(19) United States
(12) Patent Application Publication
(10) Pub. No.: US 2013/0106323 A1
(43) Pub. Date: May 2, 2013

(54) Control Device and Method for Controlling an AC Motor

(71) Applicant: Torbjorn Haugland, Bergen (NO)

(72) Inventor: Torbjorn Haugland, Bergen (NO)

(73) Assignee: Rolls-Royce Marine As Power Electric Systems Bergen, Bergen (NO)

(21) Appl. No.: 13/808,605

(22) PCT Filed: Jul. 5, 2011
(86) PCT No.: PCT/NO11/00192

§ 371 Date: Jan. 7, 2013

(30) Foreign Application Priority Data
Jul. 6, 2010 (NO) 20100985

(51) Int. Cl. H02P 25/16

(52) U.S. Cl. CPC H02P 25/16
USPC 318/376; 318/503

(57) ABSTRACT

Control device (30) and method for controlling an AC motor (18) by means of a motor control unit (19). The control device (30) includes an AFE unit (33) arranged in parallel with the rectifier unit (12), which AFE unit (33) is arranged for, under normal operation, to work as an active filter and inject super-harmonic current components opposite of the ones generated by the rectifier unit (12) to counteract the current distortion, seen from the grid side. When the motor control unit (19) is running regenerative, the AFE unit (33) will work as a 4-quadrant converter and supply energy back to the supply grid (13). Advantages of the invention are reduced physical size, lower cost and improved efficiency compared to existing solutions of motor drive with frequency converters in weak grids, where the motor drive must handle regenerative operation.

The present invention relates to a control device for controlling an AC motor according to the preamble of claim 1.

The present invention further relates to a method for controlling an AC motor according to the preamble of claim 13.

### BACKGROUND

Rotational speed control of electric motors become more and more usual nowadays, due to requirements of accurate process control and energy saving.

The most common way to control the rotational speed of an electric motor is by the use of a frequency converter.

The frequency converter converts the alternating voltage with fixed frequency and voltage of the supply source to DC voltage, for next to utilize this DC voltage to provide an alternating voltage with varying frequency and voltage which is supplied to the electric motor.

It is usually used a common diode rectifier to convert alternating voltage to DC voltage, which results in that the frequency converter draws a current which is not sinusoidal from a supply grid, i.e. a current which does not have the same shape as the voltage.

Nonlinear current consumption can be decomposed into sinusoidal currents with different frequency, so-called harmonic currents where the first harmonic is the fundamental frequency.

This can be a problem if the supply grid is weak, i.e. the load from the frequency converter is large in relation to the impedance in the supply grid. The nonlinear current results in a distortion of the grid voltage which is not desirable. This is a well-known problem on, for example, vessels with electrical propulsion which utilizes frequency converters on the electrical motors powering the propellers.

Today, several solutions are in use for converting alternating voltage of the supply grid to DC voltage with minimal distortion of the grid voltage. Common for all these are that the frequency converter is more complex, physically larger and more expensive.

From US 20100076612 A1 it is known a machine which includes several AFE units connected to provide DC on a DC bus, where the DC bus is electrically connected to a number of amplifiers, where each amplifier supplies alternating current to a number of motors.

HOVENARRS A H ET AL: “Meeting new marine harmonic standards” PETROLEUM AND CHEMICAL INDUSTRY CONFERENCE, 2008. PCIC 2008. 55TH IEEE, IEEE, PISCATAWAY, NJ, USA, Sep. 22, 2008 (Sep. 22, 2008), page 1-9, XP031355684, ISBN: 978-1-4244-2520-4, page 5, paragraph VII, describes an active filter for injection of current components for counteracting the effect of the load current of a non-linear load.

U.S. Pat. No. 6,166,513 A describes an electrical propulsion system and method for controlling an AC motor wherein a multi-phase power converter having multiple secondary windings provides multi-phase power to multiple power cells which provide four quadrant operation. This solution is only possible to use for supplying power back to the source from a motor control unit, and that it is not capable of handling circulating currents.

The known solutions can be summarized as follows:

6-Pulse: A standard rectifier solution which allows a high content of harmonic distortion on the supply grid, but other equipment supplied from the supply grid is adapted to tolerate high distortion, and that there is used a filter for equipment which does not tolerate high distortion. Braking chopper and braking resistances are necessary to handle reverse power.

12/24-Pulse: Utilizes a transformer in front of the frequency converter with several secondary windings which are phase displaced in relation to each other, which results in that the current consumption is distributed over a larger part of the period and that the distortion is reduced. Also here a braking chopper and braking resistances are required to handle reverse power.

AFE: An active rectifier solution where diodes in the rectifier are replaced by active components. One has here the possibility to control the current consumption from the supply grid and supplying reverse power back to the supply grid.

Filter: A solution used together with a 6-pulse diode rectifier with an active or passive filter mounted in the grid or in front of a frequency converter to cancel the effect of harmonics. Also here braking chopper and braking resistances are required to handle reverse power.

Disadvantages of the solutions mentioned above are, among other things, high costs due to a need for a 100% AFE unit or a phase change transformer, and the need for braking chopper and braking resistances to handle reverse power.

Another disadvantage of prior art is complicated installation and complicated technical work to take harmonics and resonance problems into consideration.

A third disadvantage is high total volume and weight as one need a large phase change transformer or a 100% AFE unit, and braking resistances and braking choppers.

A fourth disadvantage is reduced efficiency due to loss in phase change transformer, loss in active components in rectifier unit, and loss in braking chopper and braking resistances as the energy is unrecoverable. Use of braking resistances will also result in additional installation, installation of additional cooling for the same.

A fifth disadvantage is high complexity of the total system, as cabling which need to go via phase change transformer or supply from several switchboard is required, and that external filters or special configurations are required to meet demands with regard to minimum distortion in the supply grid.

### Object

The main object of the present invention is to remove the disadvantages of the prior art mentioned above.

It is further an object of the present invention is to provide a control device having a low content of harmonic current consumption from the supply grid and which at the same time is regenerative.

An object of the present invention is to provide a control device which gives a lowest possible total volume and high arrangement ability.

Further, it is an object that the invention shall result in lower costs for equipment and installation.

It is further an object that the control device shall have at least the same efficiency or higher efficiency than prior art control devices.

Another object of the invention is that the control device shall have lower complexity than prior art control devices.

Another object of the present invention is to provide a control device which simplifies technical work by that it is not necessary to take harmonic distortion into considerations when calculating work for the electric installations.

Finally, it is an object of the invention to provide a method for controlling an AC motor with the objects mentioned above.

### The Invention

A control device according to the invention is described in claim 1. Advantageous features of the control device are described in the claims 2-11.

A method according to the invention is described in claim 13. Advantageous features of the method are described in the claims 14-19.

The starting point for the present invention is to provide a solution which satisfies the desire to have a control device that draws a current from the supply grid which is mainly sinusoidal and which hence does not create any form for distortion on the supply grid it is supplied from, and at the same time as the control device is regenerative.

It is also a desire that motor control units of a standard type can be used for controlling an AC motor.

The starting point for a control device according to the invention is a frequency converter having a standard diode rectifier unit with low power loss. According to the invention the control device includes a smaller Active front-end unit (AFE unit) together with a LCL filter arranged in parallel with the rectifier unit.

The AFE unit will under normal operation work serve as an active filter and inject superharmonic current components opposite to the ones generated by the rectifier unit to counteract the current distortion, seen from the supply grid side. When the motor control unit runs regenerative, the smaller AFE unit will work as an ordinary 4-quadrant converter and supply energy back to the supply grid.

The size of the AFE unit is given by how large current components which need to be injected back on the supply grid to counteract undesired effect of the rectifier unit, and by how large the need is for being able to supply back regenerative energy. System assessments can also be done, which can result in a somewhat smaller AFE unit.

The AFE unit includes means for measuring voltage quality and current consumption to the rectifier unit in order to be able to calculate magnitude and phase angle of current which has to be injected. In this way the AFE unit can supply the rectifier unit with the superior current components it consumes. It will then, seen from the supply grid side, only be the basic harmonic which is consumed.

Moreover, the AFE unit preferably includes means for reading the voltage in an intermediate circuit, i.e. the circuit between the control device and the motor control unit, and that the AFE unit is arranged to use the voltage in the intermediate circuit to control when is must start to run regenerative, i.e. when there is excess energy in the intermediate circuit. When the motor is braked or is running regenerative, there will go no current through the rectifier and it is thus no need for injecting superharmonic components and the AFE unit can therefor be fully utilized to supply energy back to the supply grid.

A substantial challenge with connecting a rectifier unit with an AFE unit on the same DC bus is circulating currents between the rectifier unit and the AFE unit.

In order to avoid this, the control device according to an embodiment of the invention is provided with one or more switches in the rectifier unit which makes it possible to block current from passing through the rectifier unit when there is no need for energy from the supply source.

Moreover, one or more switches can advantageously be arranged in a DC voltage connection between the AFE unit and the rectifier unit, so that it is possible to block current from passing between the AFE unit and the DC bus, which can be controlled by the Active Front End control unit based on the power direction of the AC motor.

In cases where there are used switches between the AFE unit and the DC bus, so that it is necessary to lower the DC voltage from the AFE unit below the voltage from the rectifier unit, it is advantageous to use an auto-transformer at the input of the AFE unit, which reduces the voltage input to the AFE unit to enable blocking of the DC connection between the AFE unit and the DC bus.

A method for controlling an AC motor accordingly includes, by means of the AFE unit, injection opposite super-harmonic current components opposite of the ones generated by the rectifier unit, to counteract the current distortion on the grid side when the motor control unit drives the AC motor.

It includes further, by means of the AFE unit, to supply regenerative energy back to the grid when the motor control unit is running regenerative or the AC motor is braking.

Moreover, it includes measuring voltage quality and current consumption to the rectifier unit to calculate magnitude and phase angle of the current which has to be injected to counteract the current distortion on the grid side.

It also includes measuring voltage in an intermediate circuit to determine if current is to be injected or regenerative energy is to be supplied back to the supply grid.

It also includes control of switches arranged in the rectifier unit and between the AFE unit and the DC bus to block or allow current to pass.

Further advantages and preferable features of the present invention will appear from the following example description.

### EXAMPLE

The invention will in the following described in more detail by references to the attached drawings, where:

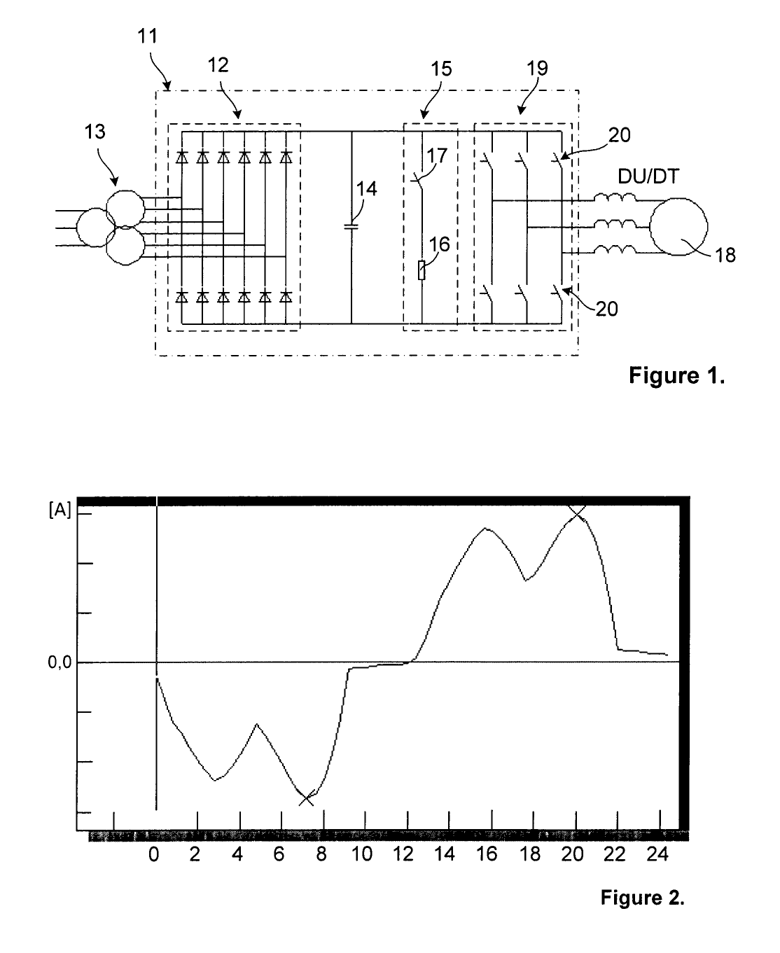

FIG. 1 is a principle drawing of a traditional control device having a frequency converter with 12-pulse rectifying, i.e. a double 3-phase diode bridge and phase change transformer at the input,

FIG. 2 illustrates typical input current on a 6-pulse diode rectifier bridge,

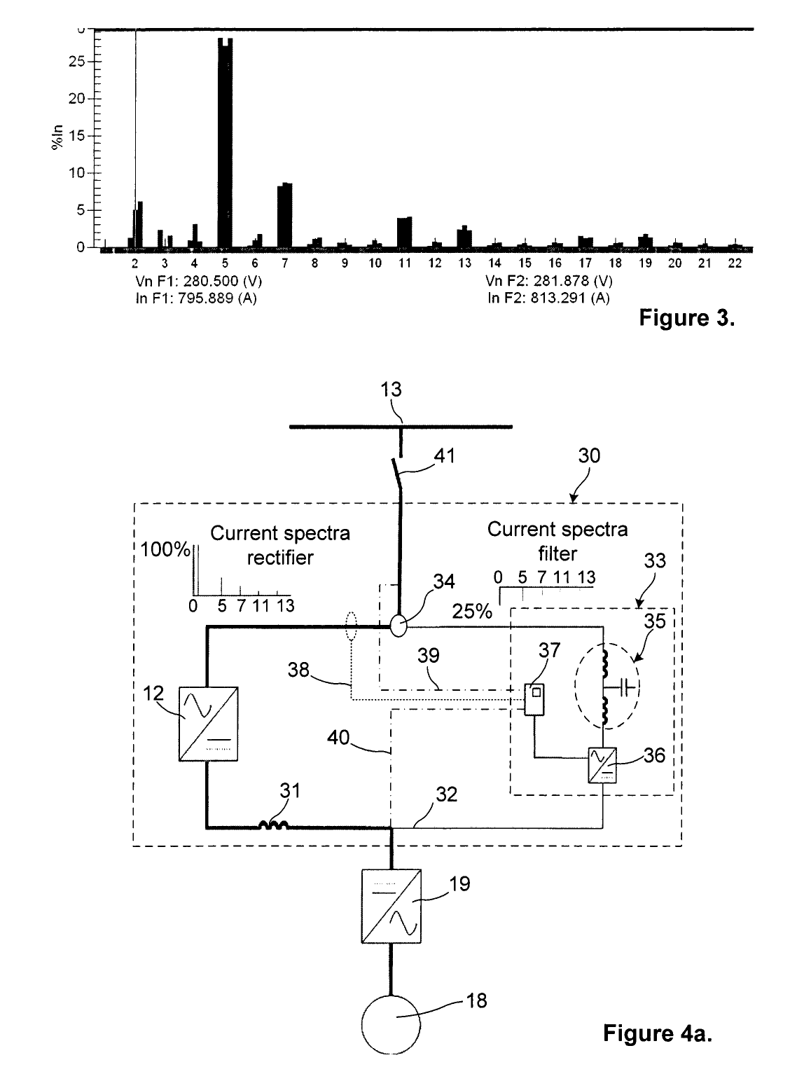

FIG. 3 illustrates a typical current spectra and amplitude of a 6-pulse rectifier,

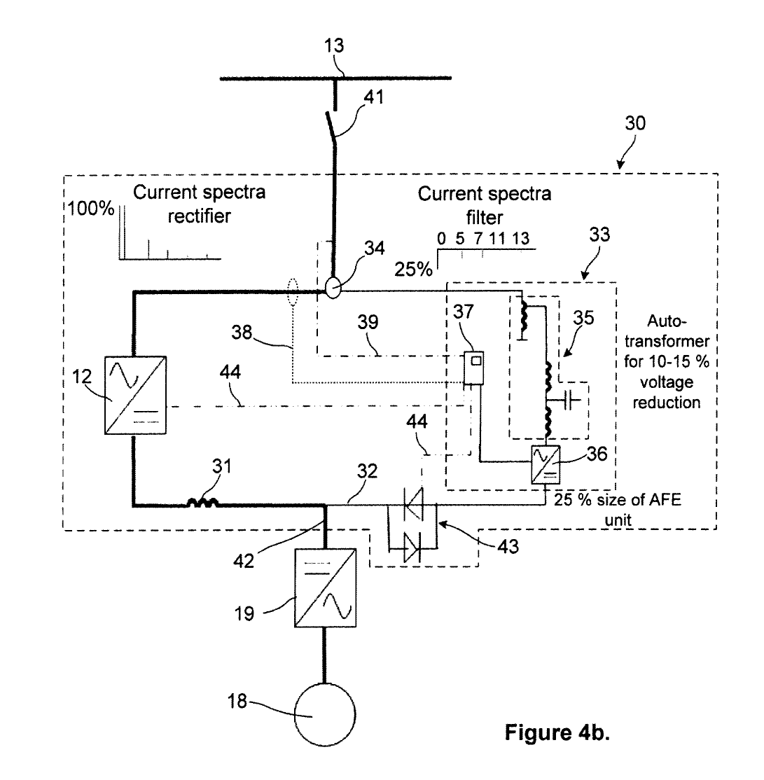

FIG. 4a is a principle drawing of a control device according to a first embodiment of the invention, and

FIG. 4b is a principle drawing of a control device according to a second embodiment of the invention.

Reference is now made to FIG. 1 which illustrates a principle drawing of a traditional control device 11 having a rectifier unit 12 in the form of a 12-pulse diode rectifier. A supply source 13 in the form of a phase change transformer supplies alternating voltage to the rectifier unit 12 which converts the supplied alternating voltage to direct voltage. This is something which results in that the control device 11 draws a current from the supply source 13 which is not sinusoidal, i.e. a current which does not follow the voltage.

Moreover, the system preferably includes a capacitor 14 in parallel with the rectifier unit 12 to smooth the ripple of the direct voltage and to maintain a stable voltage in the intermediate circuit. The control device further includes, in parallel with the capacitor 14, a circuit 15 for removal of excess energy, consisting of a braking resistance 16 and a braking chopper 17. Circuit 15 is arranged to handle reverse power from an AC motor 18 which the control device 11 is connected to.

Moreover, the control device includes a motor control unit 19 formed by switch controls 20 for controlling the AC motor 18.

However, the simplest way of converting 3-phase alternating voltage to direct voltage will be a simple 3-phase rectifying bridge, i.e. a 6-pulse rectifier.

Reference is now made to FIG. 2, which illustrates a typical current consumption to such a bridge, seen from the grid. Typically, there will be about 25-30% total harmonic distortion of the current to the rectifier, where the dominating components will be 5^{th}, 7^{th}, 11^{th} and 13^{th} order of the basic harmonic.

Reference is now made to FIG. 3 which shows a typical current spectra and amplitude of a 6-pulse rectifier, as described above. As seen from FIG. 3, the 5^{th} order is about 25% of the basic, the 7^{th} about 8% etc.

Reference is now made to FIG. 4a which shows a principle drawing of a control device 30 for controlling an AC motor 18 according to a first embodiment of the invention. The control device 30 includes a rectifier unit 12 in the form of an AC/DC converter, preferably a 6-pulse rectifier, as described above under FIG. 2, and a DC coil 31 for smoothening current consumption and to maintain a stable voltage in a DC intermediate circuit 32. The rectifier unit 12 will together with the DC coil 31 convert alternating current from a supply source 13 to direct voltage which further will supply a direct voltage intermediate circuit 32 with direct voltage. Moreover, the control device 30 includes an Active Front End unit 33 (AFE unit) in parallel with the rectifier unit 12 and the DC coil 31 for converting alternating voltage to direct voltage to an AC connection 34 in connection with supplying regenerative energy back to the supply source 13, and to inject super-harmonic current components opposite of the ones generated by the rectifier unit 12 to counteract the current distortion at the grid side. The AFE unit 33 includes one or more LCL filters 35, and an AC/DC converter 36 with an Active Front End control unit 37.

The AFE control 37 is preferably provided with means for measuring/reading current consumption 38 and voltage quality 39 caused by the rectifier unit 12, and means 40 for reading the voltage in the DC intermediate circuit 32

Reference is now made to FIG. 4b, which illustrates a principle drawing of a control device 30 for controlling an AC motor 18 according a first embodiment of the invention. A substantial challenge with connecting a rectifier unit 12 and an AFE unit to the same DC bus 42 is circulating currents between the rectifier unit 12 and the AFE unit 33.

In order to avoid this, the control device 30 according to the invention is provided with one or more switches (not illustrated), preferably thyristor switches, in the rectifier unit 12. In this way it is possible to block current from passing through the rectifier unit 12 when there is no need for energy from the supply source.

Moreover, one or more switches 43 are advantageously arranged, e.g. thyristors or IGBT transistors (Insulated Gate Bipolar Transistor) in the direct voltage connection between the AFE unit 33 and the rectifier unit 12, so that it is possible to block current from passing between the AFE unit 33 and the DC bus 42.

The Active Front End control unit 37 is further arranged to control 44 opening and blocking of mentioned switches 43 based on power direction of the AC motor 18.

When the motor 12 is running as a motor and consumes power from the grid, thyristors in the rectifier unit 12 are open to supply power from supply source to the DC bus 42, and the switch/thyristor bridge 43 between the DC bus 42 and the AFE unit 33 is closed. The AFE unit 33 then works as an active filter.

When the motor is running as a generator, thyristors in the rectifier unit 12 are closed and the switch 43 between the DC bus 42 and the AFE unit 33 are open, so that the AFE unit 33 can supply power back to the grid. The AFE unit 33 then operates as a regenerative unit.

In order to close and open the switch 43/thyristors at the direct voltage connection between the DC bus 42 and the AFE unit 33, it is necessary to adjust the direct voltage from the AFE unit 33 both over and under the direct voltage from the rectifier unit 12. The Active Front End control unit 37 in connection with the AFE unit 33 is arranged to control direct voltage from the AFE unit 33 and in this way it is possible to control 44 the thyristors between the AFE unit 33 and the DC bus 42.

In a case where there are used thyristors 43 between the AFE unit 33 and the DC bus 42 so that it is necessary to reduce the direct voltage from the AFE unit 33 under the voltage from the rectifier unit 12, and thus lower than the voltage from the AFE unit 33 can become due to by-pass diodes in the IGBT module of the AFE unit, there is advantageously arranged an auto-transformer at the input of the AFE unit 33 which reduces the input voltage to the AFE unit 33 to make it possible to block the direct voltage connection between the AFE unit 33 and the DC bus 42.

Reference is now made to FIGS. 4a and 4b. The motor control unit 19 preferably includes a DC/AC converter and a control unit (not shown) which can operate the motor 18 by speed, frequency or power control dependent of input from an external control system (not shown).

The AFE unit 33 will typically be in order of 15-30% of the size of the main unit, i.e. the motor control unit 19, preferably 20-30%.

In this way, a control device 30 is provided which draws a current from the supply grid 13 which is mainly sinusoidal and thus creates minimal distortion on the supply grid 12 it is supplied from.

Under normal operation the AFE unit 33 will work as an active filter and inject super-harmonic current components opposite of the ones generated by the rectifier unit 12 to counteract the current distortion on the grid side. When the main unit/motor control unit 19 is running regenerative or the motor 18 is braked, the AFE unit 33 will serve as a common 4-quadrant converter and supply energy back to the supply grid 13.

The AFE unit 33 is further provided with means and/or software for calculating magnitude and phase angle of current to be injected based on measurements of voltage quality and current consumption to the rectifier unit 12. In this way the AFE unit 33 can be controlled so that it will supply the rectifier unit 12 via the AC connection 34 with the super-harmonic current components it consumes. It will then, seen from the grid side, only the basic harmonic which is consumed.

For example, at 100% motor load the AFE unit 33 will deliver about 20% of the 5^{th} order current with negative direction and about 5% of the 7^{th} order with negative direction, and will thus counteract the effect of the rectifier unit 12; see FIG. 3. It is worth mentioning that it is only the basic harmonic which transfers power that can be utilized.

The AFE unit 33 utilizes the direct voltage in the intermediate circuit 32 for controlling when it must start to run regenerative, i.e. when there is excess energy in the DC intermediate circuit 32. When the motor 18 is braked or is running a regenerative, there will be no current passing through the rectifier unit 12 and it is thus no need for injecting super-harmonic components. The AFE unit 33 can then be fully utilized to supply energy back to the supply grid 13.

It should be noted that a switch 41 is preferably arranged between the control device 30 and the supply source/supply grid 13 for connecting and disconnection of the control device 30 and the motor 18.

A challenge with this solution, compared to AFE and transformer solutions, is that the voltage in the DC intermediate circuit 32 is completely dependent of the grid voltage and will decrease with increasing motor load. In a solution with transformers or AFE it is possible to compensate for this. Size of frequency converter and design of motor voltage must therefore be adapted to take this in consideration. It must be used a motor voltage which has sufficient DC voltage to maintain. For example, in a 690 V system, the motor voltage would have to be reduced to 660 V. The current capacity must be correspondingly higher to maintain the efficiency of the motor.

The advantage of the present invention compared to existing solutions is, among other things, lower costs due to that one saves the costs of a 100% AFE unit or phase change transformer. It will neither be necessary to have braking chopper or braking resistances, and the installation and technical work for a control device according to the invention will be simplified as one not need take harmonic problems and resonance problems into consideration.

Another advantage is lower total volume, as there is no need for a large phase change transformer or a 100% AFE unit, and braking resistances and braking chopper.

A third advantage is higher efficiency, as the present invention will have no loss in phase change transformer. Reduced loss in switches due to a smaller AFE unit, and regeneration of braking energy will also result in higher efficiency.

A fourth advantage is lower complexity of the total system. The present invention provides a simple installation, and cabling directly to the consumer without going via phase change transformer or supply from several switchboards. Moreover, there is no need for external filters or special configurations to handle requirements for maximal distortion in the supply grid. There is neither necessary with installation of braking resistances nor cooling of these.

A fifth advantage is that the present invention promotes simple technical work as there is no need to take harmonic distortion from frequency converter into consideration, i.e. a control device system according to the invention will be simple to install, as a traditional AFE solution.

The present invention is primarily intended for propulsion installations onboard ships, but can also have other fields of utilization which have the same problem to be addressed, such as pump installations/compressor installations offshore or onshore, or other large frequency converter installations in weak grids, i.e. grids where the load from the frequency converter is large in relation to the impedance in the supply grid.

### Modifications

The DC coil after the rectifier unit can be replaced by a three-phase AC coil in front of the rectifier unit.

To compensate for varying motor load, an energy storage unit can be arranged in the DC intermediate circuit.

The AFE unit can at low load supply the motor control unit with power. Low load will be the AFE unit power in relation to the power of the motor unit (about 25%).

A low-pass filter (RFI) can be arranged between the supply source 13 and control device 30 to prevent conducted high frequency noise from the AFE unit 33 from returning to the supply source 13.

To avoid current from passing through by-pass diodes in the AFE unit, an auto-transformer can be arranged in connection with the LCL filter 35 to reduce the voltage to the AFE unit, so that maximum value of the sinusoidal voltage does not exceed DC voltage in the DC intermediate circuit 32. This due to current through by-pass diodes in the AFE unit will interfere with the active filter function of the AFE unit. The auto-transformer is either arranged in front of the LCL filter 35 or integrated with the LCL filter 35.

1-20. (canceled)

21. A control device (30) for controlling an AC motor (18) by means of a motor control unit (19), including a rectifier unit (12), an AFE unit (33) which includes one or more LCL filters (35), an AC/DC converter (36), and an Active Front End control (37), which control the device (30) being supplied with energy from a supply source/supply grid (13), wherein the AFE unit (33) is arranged in parallel with the rectifier unit (12), for working as an active filter and injecting super-harmonic current components opposite to those generated by the rectifier unit (12) to counteract the current distortion on the grid side under normal operation, and regeneratively working as a 4-wuadrant converter and supplying energy back to the supply grid (13) when the motor control unit (19) is running.

22. The control device according to claim 21, wherein the rectifier unit (12) is provided with one or more switches to block current from passing throughput the rectifier unit (12) when there is no need for energy from the supply source (13).

23. The control device according to claim 21, including one or more switches (43) arranged to a direct voltage connection between the AFE unit (33) and the rectifier unit (12) to block current from passing between the AFE unit (33) and a DC bus (42).

24. The control device according to claim 21, wherein the Active Front End control (37) is arranged to control the one or more switches.

25. The control device according to claim 21, wherein the AFE unit (33) exhibits less power than the motor control unit (19).

26. The control device according to claim 25, wherein the AFE unit (33) has a power that corresponds to 15-50% of the power of the motor control unit (19).

27. The control device according to claim 21, wherein the AFE unit (33) is provided with means (39) for measuring voltage quality and means (38) for measuring current consumption to the rectifier unit (12).

28. The control device according to claim 21, wherein the AFE unit (33) is provided with means (40) for measuring the voltage in a DC intermediate circuit (32) to determine whether the AFE unit (33) is to inject current or to be run regenerative for supplying energy back to the supply grid (13).

29. The control device according to claim 21, wherein the AFE unit (33) is provided with means and/or software for calculating magnitude and phase angle of current to be injected and to determine magnitude of current which has to be injected to counteract the current distortion at the grid side.

30. The control device according to claim 21, wherein the rectifier unit (12) is a 6-pulse rectifier, and includes a DC coil (31) arranged after the rectifier unit (12) or an AC coil arranged in front of the rectifier unit (12) for assisting in smoothening current consumption and maintaining a stable voltage in the DC intermediate circuit (32).

31. The control device according to claim 21, wherein the motor control unit (19) includes a DC/AC converter and a control unit which can operate the motor (18) by speed, frequency or power control.

32. The control device according to claim 21, including an auto-transformer arranged in front of the LCL filter (35) or integrated with the LCL filter (35) for reducing the voltage to the AFE unit (35) to avoid current from passing through by-pass diodes in the AFE unit (33) under operation of the motor control unit (19).

33. A method for controlling an AC motor (18) by means of a motor control unit (19), a control device (30) including a rectifier unit (12), an AFE unit (33) which include one or more LCL filters (35), an AC/DC converter (36), and an Active Front End control (37), wherein the control device (30) is supplied with energy from a supply source/supply grid (13), including by means of the AFE unit (33), which is arranged in parallel with the rectifier unit (12), actively filtering and injecting super-harmonic current components opposite to the ones generated by the rectifier unit (12) to counteract the current distortion, seen from the grid side, when the motor control unit (19) operates an AC motor (18).

34. The method of claim 33, including by means of the AFE unit (33), supplying regenerative energy back to the supply grid (13) when the motor control unit (19) is running regenerative or the AC motor (18) is braking.

35. The method according to claim 33, including by means of one or more switches (43) arranged in the rectifier unit (12), blocking current passing through the rectifier unit (12) when there is no need for energy from the supply source (13).

36. The method according to claim 33, including by means of one or more switches (43), arranged to a DC voltage connection between the AFE unit (33) and the rectifier unit (12), blocking for current passing between the AFE unit (33) and a DC bus (42) based on the direction of the power of the AC motor (18).

37. The method according to claim 33, including measuring voltage quality and current consumption to the rectifier unit (12) for determining the current magnitude which needs to be injected to counteract the current distortion seen from the grid side.

38. The method according to claim 33, including calculating magnitude and phase angle of current to determine magnitude of current which needs to be injected to counteract the current distortion, seen from the grid side, based on measured voltage quality and current consumption.

39. The method according to claim 33, including measuring the voltage in a DC intermediate circuit (32) to determine if current is to be injected or regenerative energy is to be supplied back to the supply grid (13).

40. The method according to claim 33, including reducing the voltage to the AFE unit (33) by using an auto-transformer arranged in front of the LCL filter (35) or integrated with the LCL filter (35) to avoid current from passing through by-pass diodes in the AFE unit (33) under operation of the motor control unit (19), so that maximum value of sinusoidal voltage does not exceed DC voltage in the intermediate circuit (32).
